(19) United States
(12) Patent Application Publication
(10) Pub. No.: US 2026/0323381 A1
(43) Pub. Date: Oct. 15, 2026

(54) SYSTEMS AND METHODS USING COMBINED BUFFER STATUS REPORT DESIGN FOR LEGACY AND NEW XR TABLES

(71) Applicant: Telefonaktiebolaget LM Ericsson (PUBL), Stockholm (SE)

(72) Inventors: Jose Luis PRADAS, STOCKHOLM (SE); Du Ho KANG, Sollentuna (SE); Richard TANO, STOCKHOLM (SE)

(21) Appl. No.: 19/483,652

(22) PCT Filed: May 8, 2024
(86) PCT No.: PCT/SE2024/050436

§ 371 Date: Nov. 12, 2025

Related U.S. Application Data
(60) Provisional application No. 63/501,825, filed on May 12, 2023.

(51) Int. Cl. H04W 28/02

(52) U.S. Cl. CPC H04W 28/0278

(57) ABSTRACT

A method (1500) performed by a user equipment, UE (712), configured with a plurality of Buffer Status, BS, tables is provided for use in preparing a Buffer Status Report, BSR. The method includes transmitting (1502), to a network node (710), information indicating at least one BS table and/or BS table index used for preparing the BSR.

### TECHNICAL FIELD

The present disclosure relates, in general, to wireless communications and, more particularly, systems and methods using combined buffer status report design for legacy and new XR tables.

### BACKGROUND

5G is the fifth generation of mobile communications, addressing a wide range of use cases from enhanced mobile broadband (eMBB) to ultra-reliable low-latency communications (URLLC) to massive machine type communications (mMTC). 5G includes the New Radio (NR) access stratum interface and the 5G Core Network (5th Generation CN). The NR physical and higher layers are reusing parts of the Long Term Evolution (LTE) specification, and to that add needed components when motivated by new use cases.

Low-latency high-rate applications such as extended Reality (XR) and cloud gaming are important in 5G era. XR may refer to all real-and-virtual combined environments and human-machine interactions generated by computer technology and wearables. It is an umbrella term for different types of realities including Virtual reality (VR), Augmented reality (AR), Mixed reality (MR), and the areas interpolated among them. The levels of virtuality range from partially sensory inputs to fully immersive VR.

5G NR is designed to support applications demanding high rate and low latency in line with the requirements posed by the support of XR and cloud gaming applications in NR networks. 3rd Generation Partnership Project (3GPP) Release 17 contains a study item on XR Evaluations for NR. The main objectives are to identify the traffic model for each application of interest, the evaluation methodology and the key performance indicators of interest for relevant deployment scenarios, and to carry out performance evaluations accordingly in order to investigate possible standardization enhancements in potential follow-up Study Item/Work Item.

### Low-Latency High-Rate XR Applications

The low-latency applications like XR and cloud gaming require bounded latency, not necessarily ultra-low latency. The end-to-end latency budget may be in the range of 20-80 ms, which needs to be distributed over several components including application processing latency, transport latency, radio link latency, etc. For these applications, short transmission time intervals (TTIs) or mini-slots targeting ultra-low latency may not be effective.

FIG. 1 illustrates an example of frame latency measured over radio access network (RAN), excluding application & core network latencies. It can be seen that there exist frame latency spikes in RAN. The latency spike occurs due to instantaneous shortage of radio resources or inefficient radio resource allocation in response to varying frame size. The sources for the latency spikes may include queuing delay, time-varying radio environments, time-varying frame sizes, among others. Tools that can help to remove latency spikes are beneficial to enable better 5G support for this type of traffic.

In addition to bounded latency requirements, the applications like XR and cloud gaming also require high rate transmission. This can be seen from the large frame sizes originated from this type of traffic. The typical frame sizes may range from tens of kilobytes to hundreds of kilobytes. The frame arrival rates may be 60 or 120 frames per second (fps). As a concrete example, a frame size of 100 kilobytes and a frame arrival rate of 120 fps can lead to a rate requirement of 95.8 Mbps.

A large video frame is usually fragmented into smaller Internet Protocol (IP) packets and transmitted as several transport blocks (TBs) over several TTIs in RAN. FIG. 2 illustrates an example of the cumulative distribution functions of the number of TBs required to deliver a video frame with size ranging from 20 KB to 300 KB. For example, FIG. 2 illustrates that for delivering the frames with a size of 200 KB each, the median number of needed TBs is 5.

FIG. 3 illustrates XR traffic characteristics compared to Voice Over IP (VOIP) and Web-browsing. Specifically, as illustrated, the characteristics of XR traffic arrival are quite distinct from typical web-browsing and VoIP traffic. It is well expected that the arrival time is quasi-periodic and largely predictable as VoIP. However, its data size is order of magnitude larger than VoIP, as discussed above. In addition, similar to web-browsing, the data size is different at every application Packet Data Unit (PDU) arrival instance due to dynamics of contents and human motion.

### Buffer Status Report in 5G

The User Equipment (UE) reports to the network the buffer status waiting for transmission in the Medium Access Control Control Element (MAC CE) Buffer Status Report (BSR). According to Release 17, there are four different BSR formats that UEs can send to the network:
Short BSR format (fixed size)
Short Truncated BSR format (fixed size)
Long Truncated BSR format (variable size)
Long BSR format (variable size)

FIG. 4 illustrates short BSR and short truncated BSR format. FIG. 5 illustrates long BSR and long truncated BSR format.

There are 3 type of BSRs: regular BSR, periodic BSR, and padding BSR.

The regular BSR is triggered if uplink (UL) data, for a logical channel that belongs to an Logical Channel Group (LCG), becomes available to the MAC entity and either this UL data belongs to a logical channel with higher priority than the priority of any logical channel containing available UL data which belong to any LCG or none of the logical channels which belong to an LCG contains any available UL data. When more than one LCG has data available for transmission, then the UE uses the long BSR format and reports all LCGs which have data. However, if only one LCG has data, the short BSR format is used.

The periodic BSR is configured by the network. When configured, the UE reports periodically the BSR. When more than one LCG has data available for transmission, then the UE uses the long BSR format and reports all LCGs which have data. However, if only one LCG has data, the short BSR format is used.

The padding BSR is an opportunistic method to provide buffer status information to the network when the MAC PDU would contain a number of padding bits equal or larger than one of the BSR formats. In this case, the UE would add the padding BSR replacing the corresponding padding bits. In this case, the BSR format to be used depends on the number of padding bits, the number of logical channels that have data for transmissions, and the size of the BSR format. When more than one LCG has data for transmission, one of the following three formats is used: the short truncated BSR, the long BSR, or the long truncated BSR. The selection of the BSR format depends on the number of available padding bits. When only one LCG has data for transmission, then the short BSR format is used.

For a UE, one MAC PDU can contain, at most, one BSR MAC CE.

### 3GPP Standardization

During Release 18, RAN2 has discussed the enhancement of the existing buffer status report to support the high data rate and low latency XR applications.

In order to enhance the scheduling of uplink resources for XR, the following BSR improvements are under discussion during Release 18 WI:
One or more additional Buffer Status (BS) table(s) to reduce the quantization errors in BSR reporting (e.g. for high bit rates);
Delay knowledge of buffered data, consisting of for example, remaining time, and distinguishing how much data is buffered for which delay. It is to be determined whether the delay information is reported as part of BSR or as a new MAC CE. Also, how the delay information can be up to date considering, for example, scheduling and transmission delays needs to be investigated further.
Additional BSR triggering conditions to allow timely availability of buffer status information can be investigated further.

There currently exist certain challenges, however. For example, only one short BS table and one long BS table are possible for use. Thus, the problems appear when there are multiple short BS tables and/or multiple BS tables. The problem is extended when considering new BSR design such as, for example, selected table index report and delay reporting in the BSR . . .

### SUMMARY

Certain aspects of the disclosure and their embodiments may provide solutions to these or other challenges. For example, methods and systems are provided for providing a new BSR format that allows reporting the legacy BS table and index as well as the new BS tables and indexes. The new formats may also provide time-related information.

According to certain embodiments, a method by a UE configured with a plurality of BS tables for use in preparing a BSR includes transmitting, to a network node, information indicating at least one BS table and/or BS table index used for preparing the BSR.

According to certain embodiments, a UE configured with a plurality of BS tables for use in preparing a BSR is configured to transmit, to a network node, information indicating at least one BS table and/or BS table index used for preparing the BSR.

According to certain embodiments, a method by a network node includes receiving, from a UE configured with a plurality of BS tables for use in preparing a BSR, information indicating at least one BS table and/or BS table index used for preparing the BSR.

According to certain embodiments, a network node is configured to receive, from a UE configured with a plurality of BS tables for use in preparing a BSR, information indicating at least one BS table and/or BS table index used for preparing the BSR.

Certain embodiments may provide one or more of the following technical advantages. For example, certain embodiments may provide a technical advantage of enabling a network to intelligently understand the type of BSR when a new BSR with a table identifier (ID) is configured. As another example, certain embodiments may provide a technical advantage of enabling a network to give the optimal size of uplink grant to increase capacity with minimizing resource waste.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example of frame latency measured over radio access network (RAN), excluding application & core network latencies;

FIG. 2 illustrates an example of the cumulative distribution functions of the number of transport blocks required to deliver a video frame;

FIG. 3 illustrates XR traffic characteristics compared to VoIP and Web-browsing;

FIG. 4 illustrates short BSR and short truncated BSR format;

FIG. 5 illustrates long BSR and long truncated BSR format;

FIG. 6 illustrates a graph demonstrating XR capacity at various eMBB load points with different BS table step sizes (in bytes), according to certain embodiments;

FIG. 7 illustrates an example table/BS format when each LCG has only one new BSR configured, according to certain embodiments;

FIG. 8 illustrates an example Table/BS format when each LCG has more than one new BSR configured, according to certain embodiments;

FIG. 9 illustrates an example Table/BS format when two new BSR tables per LCG is configured, according to certain embodiments;

FIG. 10 an example Table/BS format having two bits for each LCG that was configured with new tables, according to certain embodiments;

FIG. 11 illustrates an example Table/BS format in which all buckets contain data, according to certain embodiments;

FIG. 12 illustrates an example Table/BS format which indicates two new tables, according to certain embodiments;

FIG. 13 illustrates an example Table/BS format which has a longer L/N bit field to indicate the legacy and new table index together, according to certain embodiments;

FIG. 14 illustrates an example for reporting time-related information when only LCG has a data but three delay buckets are present, according to certain embodiments;

FIG. 15 illustrates an example Table/BS format when two delay buckets contain data, according to certain embodiments;

FIG. 16 illustrates an example communication system, according to certain embodiments;

FIG. 17 illustrates an example UE, according to certain embodiments;

FIG. 18 illustrates an example network node, according to certain embodiments;

FIG. 19 illustrates a block diagram of a host, according to certain embodiments;

FIG. 20 illustrates a virtualization environment in which functions implemented by some embodiments may be virtualized, according to certain embodiments;

FIG. 21 illustrates a host communicating via a network node with a UE over a partially wireless connection, according to certain embodiments;

FIG. 22 illustrates an example method by a UE configured with a plurality of BS tables for use in preparing and/or transmitting a BSR, according to certain embodiments;

FIG. 23 illustrates an example method by a network node, according to certain embodiments;

FIG. 24 illustrates a method performed by a UE configured with a plurality of BS tables for use in preparing a BSR, according to certain embodiments; and

FIG. 25 illustrates a method performed by a network node, according to certain embodiments.

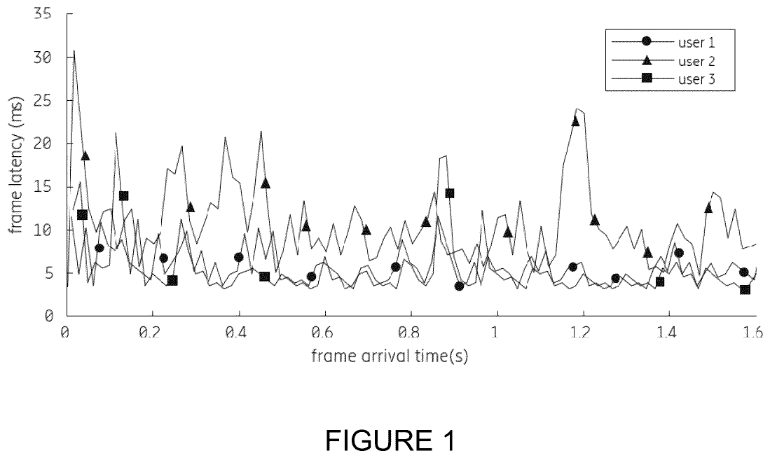

### DETAILED DESCRIPTION

Some of the embodiments contemplated herein will now be described more fully with reference to the accompanying drawings. Embodiments are provided by way of example to convey the scope of the subject matter to those skilled in the art. Additional information may also be found in the document(s) provided in the Appendix.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g. in a gNB), Distributed Unit (e.g. in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g. Mobile Switching Center (MSC), Mobility Management Entity (MME), etc.), Operations & Maintenance (O&M), Operations Support System (OSS), Self Organizing Network (SON), positioning node (e.g. E-SMLC), etc.

Another example of a node is user equipment (UE), which is a non-limiting term and refers to any type of wireless device communicating with a network node and/or with another UE in a cellular or mobile communication system. Examples of UE are target device, device to device (D2D) UE, vehicular to vehicular (V2V), machine type UE, MTC UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise base station, radio base station, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g. in a gNB), Distributed Unit (e.g. in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation RAT, NR, 4G, 5G, etc. Any of the equipment denoted by the terms node, network node or radio network node may be capable of supporting a single or multiple RATs.

The term signal or radio signal used herein can be any physical signal or physical channel. Examples of downlink (DL) physical signals are reference signal (RS) such as Primary Synchronization Signal (PSS), Secondary Synchronization Signal (SSS), Channel State Information-Reference Signal (CSI-RS), Demodulation Reference Signal (DMRS) signals in SS/PBCH block (SSB), discovery reference signal (DRS), Cell Specific Reference Signal (CRS), Positioning Reference Signal (PRS), etc. RS may be periodic. For example, RS occasions carrying one or more RSs may occur with certain periodicity (e.g., 20 ms, 40 ms, etc.). The RS may also be aperiodic.

Each SSB carries New Radio-Primary Synchronization Signal (NR-PSS), New Radio-Secondary Synchronization Signal (NR-SSS) and New Radio-Physical Broadcast Channel (NR-PBCH) in four successive symbols. One or multiple Synchronization Signal Blocks (SSBs) are transmitted in one SSB burst which is repeated with certain periodicity such as, for example, 5 ms, 10 ms, 20 ms, 40 ms, 80 ms, and 160 ms. The UE is configured with information about SSB on cells of certain carrier frequency by one or more SS/PBCH block measurement timing configuration (SMTC) configurations. The SMTC configuration comprising parameters such as SMTC periodicity, SMTC occasion length in time or duration, SMTC time offset with regard to reference time (e.g., serving cell's SFN) etc. Therefore, SMTC occasion may also occur with certain periodicity (e.g., 5 ms, 10 ms, 20 ms, 40 ms, 80 ms, and 160 ms). Examples of uplink (UL) physical signals are reference signals such as Sounding Reference Signals (SRS), Demodulation Reference Signals (DMRS), etc. The term physical channel refers to any channel carrying higher layer information e.g. data, control etc. Examples of physical channels are Physical Broadcast Channel (PBCH), Physical Downlink Control Channel (PDCCH), Physical Downlink Shared Channel (PDSCH), Physical Uplink Shared Channel (PUSCH), Physical Uplink Control Channel (PUCCH), Physical Uplink Shared Channel (PUSCH), Short PUSCH (sPUCCH), Short PDSCH (SPDSCH), Short PUCCH (sPUCCH), Short PUSCH (sPUSCH), MTC PDCCH (MPDCCH), Narrowband PBCH (NPBCH), Narrowband PDCCH (NPDCCH), Narrowband PDSCH (NPDSCH), Narrowband PUSCH (NPUSCH), Enhanced PDCCH (E-PDCCH), etc.

The term time resource used herein may correspond to any type of physical resource or radio resource expressed in terms of length of time. Examples of time resources are: symbol, time slot, subframe, radio frame, TTI, interleaving time, slot, sub-slot, mini-slot, system frame number (SFN) cycle, hyper-SFN (H-SFN) cycle etc.

The Release 18 XR Work Item Description includes the following objectives:
BSR enhancements including at least new BS Table(s); (RAN2);
Delay reporting of buffered data in uplink; (RAN2); See, RP-223502, New WID on XR Enhancements for NR, 3GPP TSG RAN Meeting #98-e, 12-16 Dec. 2022.

One of the Work Item (WI) goals is to introduce additional BS tables to ensure more accurate BSR reports are sent to the network. BS reports become more inaccurate, the higher the index is reported.

The following considerations should be taken into account when deciding how to create the additional BS tables:
Only specific value ranges may need to be closely monitored and have a more accurate report.
Traffic and its characteristics may vary with time. Video frames are a typical example. Different frame types (e.g. I-frames and P-frames) are characterized by rather different sizes and variance. In addition, rate adaptation can also change the characteristics even for the same type of frame. This results in that there will be a need to cover various non-consecutive ranges.
The importance of the accuracy may be network dependent. Networks with very high spare capacity might not be concerned about having accurate values, while those networks with limited capacity may need much more accurate reports.
The specific ranges that may need to be covered is also dependent on the typical buffer size which is impacted by other traffic services running and network and UE features deployed.

According to certain embodiments, for example, the system and methods provide a BSR format for which new BSR tables for XR applications are configured in addition to the legacy BSR table. In a particular embodiment, for example, an extra bit field indicates the usage of legacy BSR table per logical channel group. Depending on a specific new table configuration, a various BSR format is proposed.

According to certain embodiments, a network has new BS tables that may be indicated by a network in addition to legacy short and long BS tables. The number of new BSR tables can be more than one. When the multiple new tables are configured, a UE may report the BS table index that is used to report the Buffer Status. Thus, according to certain embodiments, a new BSR format is designed in order to ensure UE indication when new BS tables for XR are configured to use together with a legacy BS table.

The new long BSR format is designed taking as a baseline the legacy BSR format. However, according to certain embodiments, new fields are added.

For example, in a particular embodiment, a new additional byte is added in which each bit indicates whether the legacy table (L) is used or the new (N) table is used.

### Buffer Reporting

### Tables Creation: Static and RRC-Based

Three different options to create tables were discussed in RAN2: static tables, RRC-based tables, or both static and RRC-based tables.

If static tables are introduced so that the tables are pre-loaded at the UE, these tables will need to cover the full BS value range since any specific part of the range may be wanted. The maximum BS value range for the 5-bit BS table is currently 150 000 bytes while it is 81 338 368 bytes for the 8-bit BS table.

If a network wants a maximum inaccuracy of 40 bytes, 3750 indexes are needed which results in the need of 118 tables each having 32 indexes. If inaccuracy would be 100 bytes or 200 bytes, 47 and 24 tables, respectively, would still be needed. When this is applied to the 8-bit BS table, it would result in up to approximately 1600 tables with a 200 bytes inaccuracy.

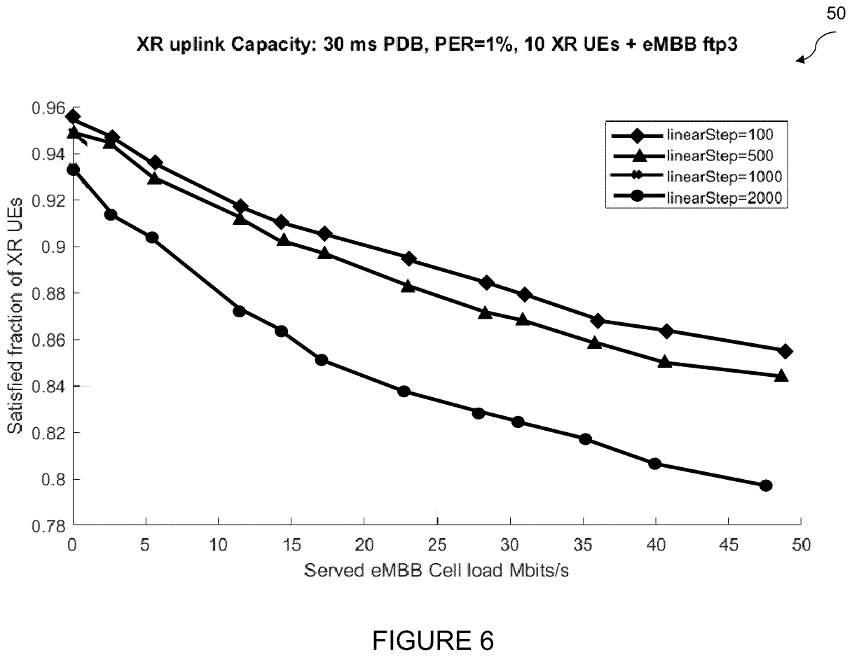

Through simulations it can be investigated what BS table accuracy levels that is needed to get performance improvements. FIG. 6 illustrates a graph 50 demonstrating XR capacity at various eMBB load points with different BS table step sizes (in bytes). More specifically, FIG. 6 show the results of such evaluations where it can be seen that a smaller BS step size improve the network performance by reducing the padding in transmissions and thus free up resources that can be used to support more eMBB users. Every reduction in step size significantly improves how much eMBB data that is possible to serve. Even when reducing from a small step size of 500 bytes to 100 bytes a noticeable gain can be seen. With a target XR capacity of 90% satisfied users, the served eMBB load can be almost four times higher when going from 2000 to 100 byte step size.

There is a tight connection between the minimum size value, the maximum size value, the step, and the number of indexes in the table, and a trade-off between all these parameters will be needed when deciding static tables. Simple solutions to create static tables would be to decide on a maximum and minimum size, and a certain step size, and then create as many tables needed to cover the given range. A second more elaborated and complex option would be to create multiple combinations of minimum and maximum buffer size and step sizes.

Regardless of the solution taken to create static tables, it is likely that the number of predefined tables is rather large. In addition, the UE would need to report the table index which it is using at any given time. This would also require adding many bits to indicate the table index unless additional solutions are introduced such as the NW configuring the UE with a limited set of table indexes to be used. But then, it is questionable the gain of having any static tables when RRC would still be needed.

Static tables have, therefore, several drawbacks:
Trade-off between buffer size range, granularity, and number of created static tables which results in that the gains may be limited due to the non-flexible and sub-optimal solutions.
Network conditions are not considered,
Many tables are needed to cope with different range and accuracy combinations.
Many bits to indicate the table index (in addition to the BS index) i.e. considerable overhead; or more elaborated solutions may be needed to cope with the overhead.

The above disadvantages are removed by having RRC-based BS tables. RRC can provide the configuration to build each BS table. This allows the needed flexibility so that the NW can build tables considering the network conditions, the network configuration, and the specific traffic characteristics. RRC-based BS creation is very simple mechanism to create BS tables while it allows much more flexibility at a very low overhead than fixed tables. Accordingly, it is proposed to introduce RRC-based tables.

Accordingly, it is proposed to introduce RRC-based tables. For example, according to certain embodiments, the network provides a configuration(s) for the UE to build additional BS tables. Each of these configurations can then focus on a buffer range having an accuracy the network wishes to have in such range. Having RRC-based BS tables allows the possibility to configure a limited set of tables (e.g. 1 to 4) to address the cases in which different buffer size ranges need to be cover and these ranges cannot be achieved by one single table. A larger range with the same step size or number of indexes would result in lower accuracy.

The number of tables to configure will depend on the network as well as the traffic characteristics of the different XR flows. However, a reasonable limit should be set as the table indexes may need to be reported by the UE too. Thus, 1, 2 or 4 tables per LCG should be considered. The specific value should be decided considering the BSR formats and could be different for short BS table and long BS table.

In a particular embodiment, it is proposed that the network configures one table for the newly defined Short BSR.

In a particular embodiment, it is proposed that it is preferable that the network configure more than one table per LCG for the newly defined long BSR. Value to be selected depending on the BSR format.

### BSR and BS Table Configuration

The network can provide via RRC the information elements to build each of the tables. This information is: BS table type, table index, initial value (bytes), highest value (bytes), and optionally the step size. If the step size is explicitly indicated, it could result in that all the indexes are not assigned to a buffer size range. There is no issue with that, the UE would just simply not utilize or report them.

When the UE builds the tables, it would calculate the step size, if not provided by the network, and would start assigning each BS index with a value range. The first index would indicate a range equal to the initial value and limited by the initial value plus the step size. This is exemplified in the Table 1 in which an initial value of 1000 bytes was indicated, and the step size was 40 bytes.

TABLE 1
Example of New BS Table

| BS index | BS Value |
|---|---|
| 0 | ≥1000 & ≤1040 |
| 1 | ≤1080 |
| 2 | ≤1120 |
| 3 | ≤1160 |

In a particular embodiment, BS tables are defined by: an index, min value, max value, and stepSize.

In a particular embodiment, if stepSize is not provided, the UE calculates the step size as the (max value−min value)/(nr of indexes in the BS table)

In a particular embodiment, Tables are built as exemplified in Table 2. For BS index 0, BS value is defined by: [≥ min value & ≤min value×(stepSize×(BS index+1) For next BS indexes, BS value is defined by [≤min value×(stepSize×(BS index+1)] Until reaching the max value.

As already agreed, to simplify the configuration and implementation, each LCG would be configured to use a set of additional BS tables. This is exemplified in the ASN.1 code below:

| | |
|---|---|
| MAC-CellGroupConfig ::= | SEQUENCE { |
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M
...
[[

| | |
|---|---|
| bsTablesList-r18 | SEQUENCE(Size (1..maxLCG (8))) of |
| BsTableList | OPTIONAL, |

]]

| | |
|---|---|
| BsTableList ::= | SEQUENCE { |
| logicalChannelGroupIndex | ENUMERATED (0..maxLCG-ID), |
| shortBsTableConfigList | BsTableConfig |

OPTIONAL,

| | |
|---|---|
| longBsTableConfigList | SEQUENCE(Size (1..aa)) OF |
| BsTableConfig | OPTIONAL |

}

| | |
|---|---|
| BsTableConfig ::= | SEQUENCE { |
| index | INTEGER (0..aa−1), |
| minValue | INTEGER (xx..yy), |
| maxValue | INTEGER (nn..mm), |
| stepSize | INTEGER (bb..cc) OPTIONAL |

}

In a particular embodiment, the network associates a LCG with up to “aa” (aa depends on Proposal 2) tables for a new long BSR.

In a particular embodiment, the ASN.1 outlined above is adopted for the RRC-based BS table configuration.

RAN2 agreed to have linear tables; however, it is not yet decided whether other approaches can be used to create tables. Considering that the goal behind is to minimize the inaccuracy, exponential distributions are not very suitable. The quantization error is very small at the beginning and large as the indexes grow. The lower part of the exponential distribution, which is the only interesting part, could well be defined by a linear distribution with a small step. Thus, there may be no benefit to introduce any other type of distribution as it does not offer any additional gain.

In a particular embodiment, only linear distribution is allowed for BS table creation.

### BSR Format

### New Short Buffer Format

For short BSR, the simplest solution is to allow one new table, which could be different for each LCG. Since the LCG is reported in the short BSR format, there is no need to indicate the table. When the new BS table is used, the UE would use a newly assigned LCID index (taken from eLCID) for this type of new Short BSR, while the UE would use the legacy Short BSR LCID index (61) to report a buffer size outside of the range covered by the new table.

In a particular embodiment, one new 5-bit BS table can be configured per LCG.

In a particular embodiment, the new BSR has the same format as the legacy short BSR.

In a particular embodiment, the LCID index in the MAC subheader to identify this new short BSR should be taken from the eLCID field.

RAN2 to discuss if more tables can be configured.

### New Long Buffer Format

According to certain embodiments, any new long BSR format should continue reporting the buffer size for those LCGs which do have data in the buffer. There are three questions to resolve:
Can multiple BS tables be configured per each LCG? And,
How many bits the BS report should be, and
How to indicate if the UE is using legacy BS table or a new BS table

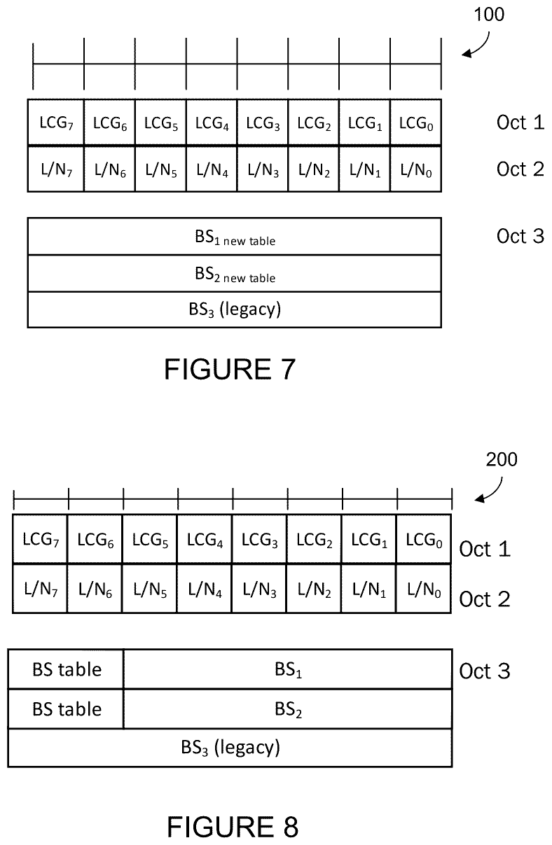

If only one new table per logical channel group is configured, a new additional byte could be added. Each bit would indicate whether the legacy table (L) is used or the new (N) table is used. For example, FIG. 7 illustrates an example table/BS format 100 when each Logical Channel Group (LCG) has only one new BSR configured, according to certain embodiments. Example table/BS format 100 may be referred to as ‘option one’, herein.

Specifically, in the example depicted in FIG. 7, two LCGs would set the L/N flag to “1”, while one LCG would set the “L/N” flag to “0” to indicate it is using legacy table. A UE will add three to indicate the BS index for three LCGs and the reported BS index would correspond to the new BS table or the legacy BS table are reported in the L/N flag.

This solution only allows reporting one new table regardless if it is per LCG or common to all LCGs.

However, having more than one new table is quite important as covering different ranges may be needed. Thus, according to certain embodiments, two or four tables may be configured. In some particular embodiments, two or four tables may be preferred. In this case, additional bits will be needed to indicate them in each BS index report.

FIG. 8 illustrates an example Table/BS format 200 when each LCG has more than one new BSR configured, according to certain embodiments. Example Table/BS format 200 may be referred to as ‘option two,’ herein.

Specifically, FIG. 8 shows an option in which the L/N would mean legacy or new table and an additional one or two bits, “BS table”, would be taken to indicate the new table index in each new table octet. In the example in FIG. 8, the “BS table” consists of two bits and, thus, it can indicate one out of four new tables. When the UE sets “L”-bit to zero, it will use eight bits to indicate the BS size using the legacy 8-bit BS table. In this example, two LGCs would set the L/N flag to “1” and would report 6 or 7-bit BS length together with the BS table index. On the other hand, one LCG would set the “L/N” flag to “0” to indicate it is using legacy table. With this format, up to 4 new BS tables could be configured and used by the UE if two bits are used for the “BS table” field, or two new tables if only one bit is used for the “BS table” field.

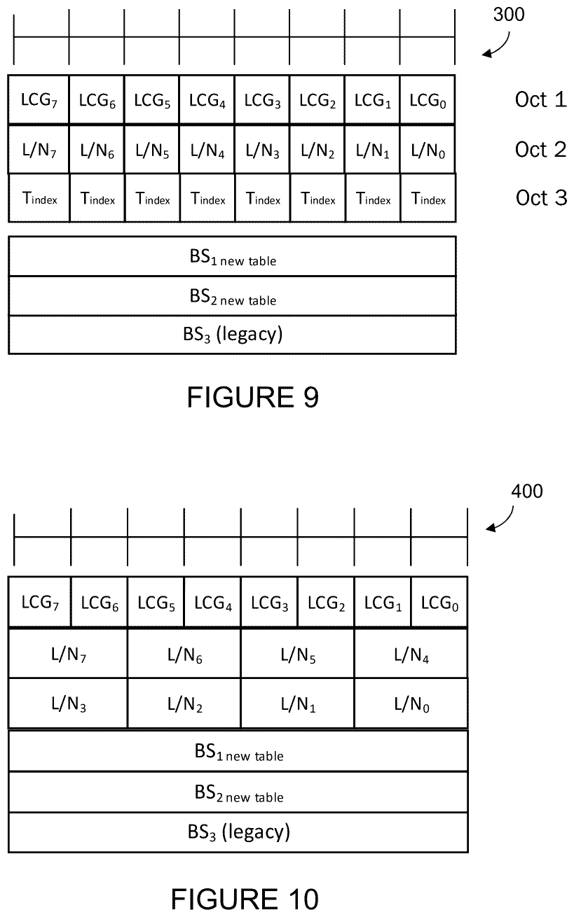

If the number of new BSR tables is limited to two, another byte can be added after the L/N, which would indicate which of two new tables. It allows to indicate at least two new tables while still having 8-bit BS fields, at the cost of having one extra byte of overhead. FIG. 9 illustrates an example Table/BS format 300 when two new BSR tables per LCG is configured, according to certain embodiments. Example Table/BS format 300 may be referred to as ‘option 3,’ herein, and may be an alternative to option 2, discussed above. It allows to indicate at most two new tables while still having 8-bit BS fields, at the cost of having one extra byte of overhead. In this example, two LCGs would set the L/N flag to “1”. For these ones, the T-field would indicate one out of two new tables specific for that LCG with 1 bit. On the other hand, one LCG would set the “L/N” flag to “0” to indicate it is using legacy table.

For example, in FIG. 9, two LGCs would set the L/N flag to “1”. For these ones, the T-field would indicate one out of two new tables specific for that LCG with 1 bit. On the other hand, one LCG would set the “L/N” flag to “0” to indicate it is using legacy table. The extra byte with T-fields would only be needed if any of the LCGs uses a new BS table.

Another alternative is to have two bits for each LCG that was configured with new tables. One of the values indicates the legacy table (e.g. 00), while the other three values would indicate one out of three tables which could be configured. The L/N field would only be present for those LCGs which were configured to use new tables. Therefore, the overhead of this solution would still be, for most cases, one byte. This option allows to configure three new tables at the cost of only one byte even when four LCGs are configured with new tables.

FIG. 10 illustrates an example Table/BS format 400 having two bits for each LCG that was configured with new tables, according to certain embodiments. Example Table/BS format 400 may be referred to as ‘option 4,’ herein As illustrated, the first two LCGs have set the L/N flag to the new BS table index while the third LCG have set the “L/N” flag to, for example, “00” to indicate it is using legacy table. If those three LCGs are the only ones with data then only three L/N fields would be present, not all the ones represented in FIG. 10.

A summary of the described options is provided in Table 2:

TABLE 2

| | Option 1 | Option 2 | Option 3 | Option 4 |
|---|---|---|---|---|
| Nr of BS tables | 1 new | 2 new (or 4 new) | 2 new | 3 new |
| BS field length | 8 bits | 7 bits (or 6 bits) | 8 bits | 8 bits |
| Overhead | 1 byte | 1 byte | 2 bytes | 1 to 2 bytes |

From an overhead point of view, option 3 and option 4 are quite similar. In the worst case, both options take two extra bytes. However, in reality, all LCGs will not be configured with new tables and all LCGs will not likely have data in their buffer at the same instance. Thus, option 4 will typically present an overhead of 1 byte in normal cases. Another advantage is that with option 4, the NW could configure up to 3 tables for each LCG.

Considering the advantages as well as the overhead, option 4 and option 2 may be the preferable alternatives, in certain embodiments.

In a particular embodiment, BS format can indicate up to three additional 8-bit BS tables (in addition to legacy table).

In a particular embodiment, option 4 may be selected for the table/BS format.

In a particular embodiment, the eLCID (1 octet) is used to for this new long BSR MAC CE.

### BSR Operation and Triggers

When the BSR is triggered and the UE calculates the total buffer size of the LCG, there may be the cases in which more than one table contains an index which can represent the UE buffer size. When this is the case, the UE should always select the index which 1) returns the smallest difference between the minimum and maximum value of the represented index 2) represents the UE buffer size.

When the buffer size value is outside the range covered in the different tables. For example, when only one table contains an index which can represent the UE buffer size, which will typically be the legacy table, the UE uses the corresponding BS tables and formats, in a particular embodiment.

In a particular embodiment, when multiple tables contain an index which can represent the UE buffer size, the UE uses the BS table/index that minimizes the index error (smallest different between the minimum and maximum value represented by the index) and represents the UE buffer size.

In a particular embodiment, when only one table (including legacy BS tables) contains an index which represents the UE buffer size, the UE shall use the corresponding BS table and format.

Another aspect is the inter-operation between legacy BSRs and the new BSR reporting. However, the inter-operation between these 2 BSRs may be simple. If the UE is configured with additional tables, the UE always would use the table which will provide the most accurate buffer status information and uses the associated BSR format.

Legacy BSR triggering are considered suitable to meet the QoS requirements. However, it can be investigated if other triggers show additional benefits. On the other hand, XR traffic with high periodicity of data may still benefit from frequent BSR transmissions but this can be accommodated by configuration of frequent periodic BSR. These aspects need to be considered if new triggers are suggested.

In a particular embodiment, current BSR triggering conditions are the baseline conditions for the new BSR introduced above.

### Delay Reporting

During the Release 18, System Information (SI) simulations were done showing that adding delay information to the BSR is beneficial for XR capacity by utilizing the information in a delay scheduler. See, R2-2301507, Discussion on XR-specific capacity improvements, Ericsson, 3GPP TSG-RAN WG2 #121, February-March 2023. Delay scheduling works by prioritizing users efficiently by utilizing early delay information. This led to the conclusion that some delay information should be reported coupled with buffer data. See, RP-223502, New WID on XR Enhancements for NR, 3GPP TSG RAN Meeting #98-e, 12-16 Dec. 2022. A suitable place for this is in the BSR as it already contains the buffer size information. However, none of the existing BSR formats can be used for this since there need to be room for the delay information and thus a new MAC CE should be introduced.

In a particular embodiment, delay reporting should also provide buffer information utilizing new defined BS tables.

Claims have been made that only a single value of delay information should be enough to report. However, it can be shown in examples that reporting without any granularity on the time scale will not work well in all scenarios such as, for example, when there are several PDU Sets at the same time in the buffer with different time left until deadline. It is thus important that delay reporting is introduced on a more granular level than only reporting a single value. It should be noted that XR traffic has high latency requirement and thus data should not reside in the buffer for a very long time or it will anyway be regarded as useless and discarded. It can thus be assumed that there should not be a need for a large number of delay values reported however the exact number can be decided at a later stage depending on the agreement of introducing a new MAC CE. Further as there may be multiple traffic flows with different delay requirements ongoing from a UE the delay reporting should be done per LCG where preferably only LCIDs with similar delay requirements are grouped. This delay granularity increases the overhead of the reporting and thus finding a solution that limits the overhead is preferred. It should be noted that reporting the exact delay value would create a lot of overhead and is thus not practical.

In a particular embodiment, delay reporting is done by indicating bucket indexes similar as for the buffer status, per LCG.

### Delay Reporting Configuration

Since delay/latency reporting can be done in a similar fashion to the buffer size reporting procedure, by reporting an index which would indicate a delay range, these delay/latency tables can be configured by the network and indicated via RRC. In this way, the granularity can be flexible around the most relevant parts. For example, the lower indexes indicate a smaller delay range.

In a particular embodiment, the network configures the minimum and maximum delay and the steps. For example, a minimum value of 0 and maximum value of 40 ms with 4 steps, would return 4 indexes indication a range in one of them from 0 to <10 ms, another from 10 to <20 ms, and so on. The UE would report the buffer size in each of these latency/delay buckets. Latency/delay buckets could indicate queued time, for instance.

In a particular embodiment, two delay tables per LCG are configured: one for short delay reporting, another table for long delay reporting.

In a particular embodiment, a delay table is defined by: −min value, −max value, and −stepSize.

In a particular embodiment, up to eight buckets are configured for long delay reporting. One bucket is enough for short delay reporting, in a particular embodiment.

In a particular embodiment, for long delay reporting, if stepSize is not provided, the UE calculates the step size as the (max value-min value)/(nr of buckets e.g., eight)

In a particular embodiment, delay table is built as: For index 0, BS value is defined by: [≥ min value & ≤min value×(stepSize×(BS index+1) Second and third index, BS value is defined by [≤min value×(stepSize×(BS index+1)] Last bucket index is defined by ≥ min value×(stepSize×(BS index+1)] or ≥ max value (if provided).

In a particular embodiment, for short delay reporting, min and max value, or min and step size are provided.

For example, an example ASN.1 for configuring the delay table is provided below:

| | |
|---|---|
| MAC-CellGroupConfig ::= | SEQUENCE { |
| drx-Config | SetupRelease { DRX-Config } |

OPTIONAL, -- Need M

| | |
|---|---|
| schedulingRequestConfig | SchedulingRequestConfig |

OPTIONAL, -- Need M

| | |
|---|---|
| bsr-Config | BSR-Config |

OPTIONAL, -- Need M
...
[[

| | |
|---|---|
| DelayTablesList-r18 | SEQUENCE(Size (1..maxLCG (8))) of |
| DelayTableList | OPTIONAL, |

]]

| | |
|---|---|
| DelayTableList ::= | SEQUENCE { |
| logicalChannelGroupIndex | ENUMERATED (0..maxLCG-ID), |
| shortDelayTableConfig | DelayTableConfig |

OPTIONAL,

| | |
|---|---|
| longDelayTableConfigList | DelayTableConfig |

OPTIONAL
}

| | |
|---|---|
| DelayTableConfig ::= | SEQUENCE { |
| minValue | INTEGER (xx..yy), |
| maxValue | INTEGER (nn..mm) OPTIONAL |
| stepSize | INTEGER (bb..cc) OPTIONAL |

}

### Delay Reporting Operation and Triggers

Simulations show early delay information is important for the scheduler to do smart selection of users. Thus the delay information should be reported as early as possible, preferably it is already included in the first BSR that is sent when new data is being reported. Then if data has waited in a while in the buffer and gets closer to deadline new BSR reports should include the updated delay values since this provides network with more accurate updates of the information. The frequency of the BSR reporting could be controlled by periodic BSR configuration or by triggering BSR when buffered data enters different delay buckets where there is not already data.

In a particular embodiment, delay reporting is triggered when new data enters an empty delay bucket. The buckets which trigger the delay reporting are configured by the network.

There are mainly two options of the delay information that has been discussed, either consisting of the delay left until PDB/PSDB expires or the waiting time (i.e. time spent in buffer). Delay left is the most useful metric for the scheduler but not necessarily the metric that needs to be reported. Both waiting time or delay left could work as a reporting solution, either by the UE calculating the delay left if it gets knowledge of the delay target or the delay left can be calculated in the network if it gets knowledge about the waiting time. Since waiting time is a generally applicable metric useful also for other services that doesn't apply as critical PSDB requirements there are more benefits for selecting such reporting metric.

In a particular embodiment, delay reporting represents the waiting time for the PDU set since the first packet of the PDU set arrived to the UE buffer.

In a particular embodiment, the UE reports the buffer status in each of the delay/latency buckets.

### Delay Reporting Format

### New Short Delay Reporting

For short delay reporting, it is important to keep the overhead limited. Thus, the simplest solution would apply a similar solution as the legacy short truncated BSR. This would result in that the short delay reporting would indicate the highest priority LCG which has data in a specified bucket (configured by the network). This is the reason why the bucket sizes for short delay and long delay reporting would be different.

In a particular embodiment, a short delay reporting is introduced. Its format is the same as the legacy BSR.

In a particular embodiment, a short delay reporting indicates the highest priority LCG configured with delay reporting which has data in a bucket configured by the network.

### New Long Delay Reporting

It would be ideal that the delay reporting is as similar as possible to the BSR reporting adding, on top, a delay indication e.g., an index. Some suggestions were made to report one bucket, the most priority one. This solution would require at least one bit to indicate if BS report for the bucket is included or not. Adding one bit will, in any case, lead to add one extra byte in the format, if the BS format is used as a baseline. Thus, if one extra byte is added, it is better to report all buckets which have data.

There are multiple possible formats to convey bucket and buffer status. Certain formats that comply with that the report are described herein and include multiple buckets, an indication of the table, and the buffer size for each of those.

According to a particular embodiment, for example, for each LCG that has been configured with “delay reporting”, when the LCG has data, the reporting includes two fields indicating the presence of the buffer status for a bucket, and the table used for that buffer status. FIG. 10, which is described above, exemplifies how the format would look like when one LCG has been configure with delay reporting format, there are eight buckets and three new tables (+legacy) table can be indicated for each of the buckets. If all buckets would contain data, eight 1-byte BS fields would follow.

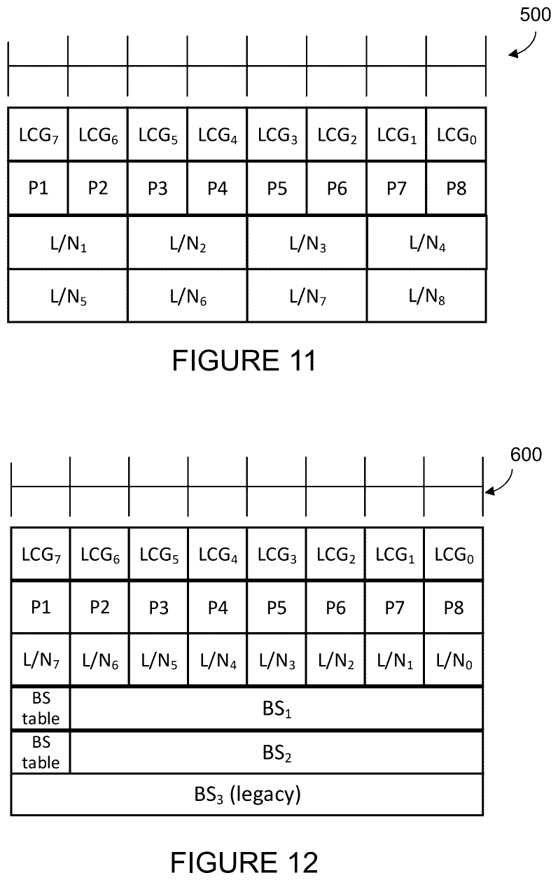

For most of the cases, only few LCGs will be configured with delay reporting and that means that in most of the cases, the overhead would be limited to two bytes per LCG which was configured with delay reporting. FIG. 11 illustrates an example Table/BS format 500 in which all buckets contain data, according to certain embodiments. Example Table/BS format 500 is referred to as option 5, herein. It is noted, However, that when a bucket does not contain data the corresponding L/N field would not be present. BS fields would follow after the L/N bits.

In another particular embodiment, an alternative option is similar as the one above, except that two new tables can be indicated. FIG. 12 illustrates an example Table/BS format 600 demonstrating this option. Example Table/BS format 600 is referred to as option 6, herein. Specifically, in the illustrated embodiment, one LCG has been configured with delay reporting with eight buckets. For each of the buckets, one bit indicates whether the legacy table or the new tables are used L/N-bit, and the BS field would consist of 7-bits adjacent to another bit which would point to one of two possible tables. In this case, two buckets use the new tables, while another bucket is using the legacy table.

In this case, 2-bytes would be needed. On the other hand, the number of new tables is limited to two and the BS length is seven bits, which is not necessary a problem.

The delay reporting format options are summarized in Table 3 below:

TABLE 3

| | |
|---|---|
| Option 1 | Option 2 |

| | | |
|---|---|---|
| Nr or delay buckets | 8 | 8 |
| Nr of BS tables | 3 new | 2 (or 4) |

| | | | |
|---|---|---|---|
| BS field length | 8 | bits | 7 bits (or 6 bits) |
| Overhead | 2-3 | bytes | 2 byte |

In a particular embodiment, one bit is used to indicate the presence of data in a bucket.

In a particular embodiment related to option one, one byte is introduced to indicate eight buckets, and BS is reported using Option 4.

In a particular embodiment, the eLCID (1 octet) is used to for this new long delay reporting MAC CE.

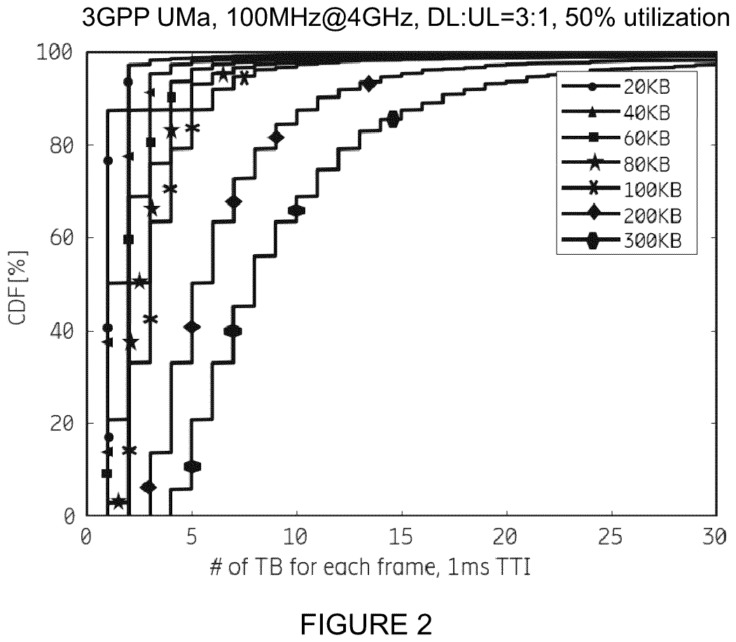

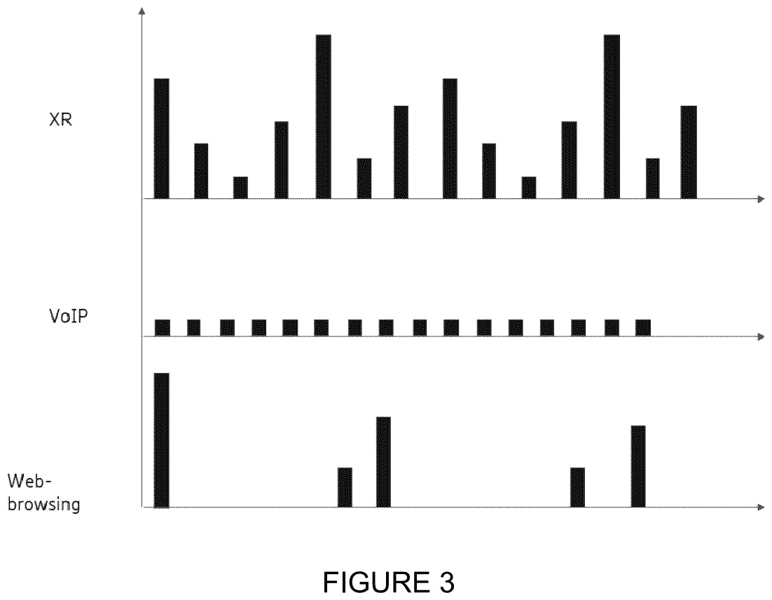

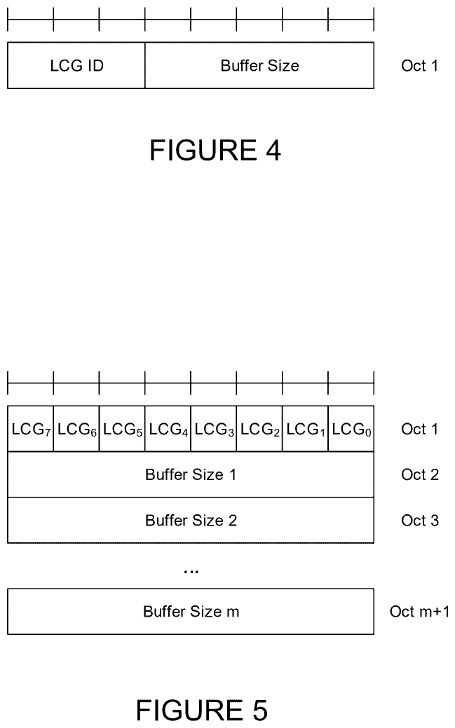

Based on the discussion above, the following embodiments are proposed:
Proposal 1 Introduce RRC-based BS tables i.e. the NW provides a configuration for the UE to build additional BS tables
Proposal 2 NW may configure 1 table for the newly defined Short BSR.
Proposal 3 It is preferable that the NW can configure more than one table per LCG for the newly defined long BSR. Value to be selected depending on the BSR format (see Section 2.3)
Proposal 4 BS tables are defined by: an index, min value, max value, and stepSize.
Proposal 5 If stepSize is not provided, the UE calculates the step size as the (max value−min value)/(nr of indexes in the BS table)
Proposal 6 Tables are built as exemplified in FIG. 2: For BS index 0, BS value is defined by: [≥min value & ≤min value×(stepSize×(BS index+1) For next BS indexes, BS value is defined by [≤min value×(stepSize×(BS index+1)] Until reaching the max value.
Proposal 7 The NW may associate a LCG with up to “aa” (aa depends on Proposal 2) tables for a new long BSR
Proposal 8 Adopt the ASN.1 outlined above for the RRC-based BS table configuration.
Proposal 9 Only linear distribution is allowed for BS table creation.
Proposal 10 One new 5-bit BS table can be configured per LCG (as in Proposal 2).
Proposal 11 The new BSR has the same format as the legacy short BSR.
Proposal 12 The LCID index in the MAC subheader to identify this new short BSR should be taken from the eLCID field
Proposal 13 RAN2 to discuss if more tables can be configured.
Proposal 14 BS format can indicate up to 3 additional 8-bit BS tables (in addition to legacy table)
Proposal 15 Select option 4 for the table/BS format.
Proposal 16 The eLCID (1 octet) is used to for this new long BSR MAC CE.
Proposal 17 When multiple tables contain an index which can represent the UE buffer size, the UE shall use the BS table/index that minimizes the index error (smallest different between the minimum and maximum value represented by the index) and represents the UE buffer size.
Proposal 18 When only one table (including legacy BS tables) contains an index which represents the UE buffer size, the UE shall use the corresponding BS table and format.
Proposal 19 Current BSR triggering conditions are the baseline conditions for the new BSR introduced in Section 2.1.
Proposal 20 Delay reporting should also provide buffer information utilizing new defined BS tables.
Proposal 21 Delay reporting is done by indicating bucket indexes similar as for the buffer status, per LCG.
Proposal 22 Two delay tables per LCG can be configured: one for short delay reporting, another table for long delay reporting.
Proposal 23 A delay table is defined by: −min value, −max value, and −stepSize.
Proposal 24 Up to 8 buckets can be configured for long delay reporting. 1 bucket is enough for short delay reporting (see 2.2.3)
Proposal 25 For long delay reporting, if stepSize is not provided, the UE calculates the step size as the (max value-min value)/(nr of buckets e.g., 8)
Proposal 26 Delay table is built as: For index 0, BS value is defined by: [≥ min value & ≤min value×(stepSize×(BS index+1) Second and third index, BS value is defined by [≤min value×(stepSize×(BS index+1)] Last bucket index is defined by ≥min value×(stepSize×(BS index+1)] or ≥max value (if provided)
Proposal 27 For short delay reporting, min and max value, or min and step size needs to be provided.
Proposal 28 Adopt the ASN. 1 outlined above to configure the delay table.
Proposal 29 Delay reporting is triggered when new data enters an empty delay bucket. The buckets which trigger the delay reporting are configured by the network
Proposal 30 Delay reporting represents the waiting time for the PDU set since the first packet of the PDU set arrived to the UE buffer.
Proposal 31 The UE reports the buffer status in each of the delay/latency buckets.
Proposal 32 A short delay reporting is introduced. Its format is the same as the legacy BSR
Proposal 33 A short delay reporting indicates the highest priority LCG configured with delay reporting which has data in a bucket configured by the network.
Proposal 34 One bit is used to indicate the presence of data in a bucket.
Proposal 35 Adopt option 1:
a. 1 byte is introduced to indicate 8 buckets.
b. BS is reported using Option 4 as in Proposal 15
Proposal 36 The eLCID (1 octet) is used to for this new long delay reporting MAC CE.

Another alternative is to have a longer bit in L/N field to indicate both BS table ID and use of legacy table.

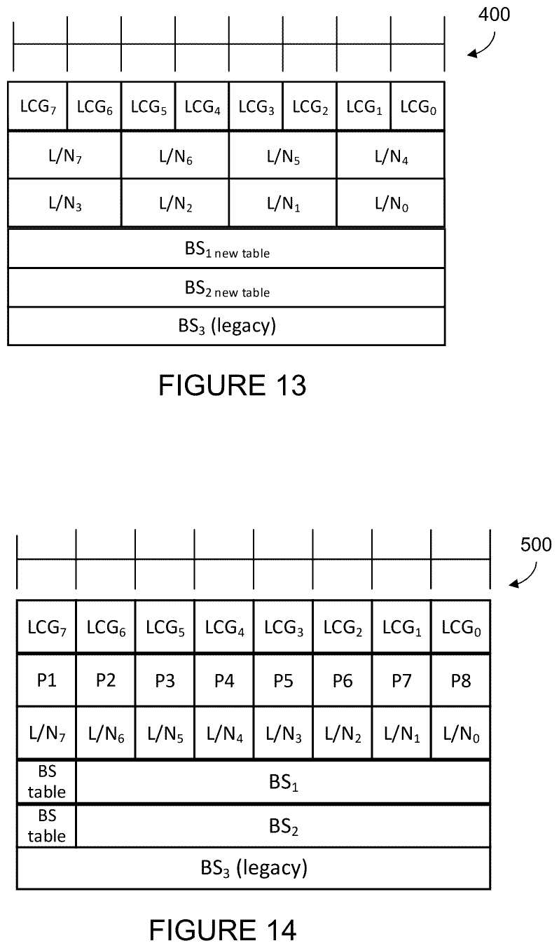

FIG. 13 illustrates an example Table/BS format 400 that has a longer L/N bit field to indicate the legacy and new table index together, according to certain embodiments. For example, as shown in FIG. 13, the BSR can have two bits for each LCG that was configured with new tables, one of the values would indicate the legacy table (e.g. 00), while the other three values would indicate one out of three tables which could be configured. The L/N field would only be present for those LCGs which were configured to use new tables. Therefore, the overhead of this solution would still be, for most cases, one byte. This option is, thus, much better as it allows to configure three new tables at the cost of only one byte even when four LCGs are configured with new tables. For example, if two LGCs would set the L/N flag to the new BS table index while one LCG would set the “L/N” flag to e.g. “00” to indicate it is using legacy table. In this example, only three L/N fields would be present, not all the ones represented in FIG. 13. In other words, there would be as many “L/N” fields are LGCs being reported, each L/N field associated to one LCG.

In another embodiment, after LCG and L/N field indication, the bytes for BS index can be added in a different way. If all L/N fields are set to 1, new BS index is added in the order of LCG with “1” from the left to right or from the right to left. Similar when all L/N fields are set to 0, the legacy BS index is added in the order of LCG with “1” from the left to right or from the right to left. When both L/N fields with “1” and with “0” are mixed (but still those have LCG with “1”), the BS index is added in a different way.
1. Add new BS index from the leftmost to the rightmost of LCG=1 and then add legacy BS index from the leftmost to the rightmost of LCG=1
2. Or Add legacy BS index from the leftmost to the rightmost of LCG=1 and then add legacy BS index from the leftmost to the rightmost of LCG=1
3. Or add BS index with LCG=1 from the leftmost to the rightmost

In a particular embodiment, a network configures which way to add BS index and also direction (i.e., from the left to the right, or from the right to the left in LCG byte, in particular embodiments).

In addition to the formats above, the UE may be configured to report time-related information such as, for example, the remaining Packet Delay Budget (PDB) left, or the queued time. Then, the UE would report a delay buffer status report to the network.

The format of this delay buffer status report could be, for instance as shown in FIG. 14. Specifically, FIG. 14 illustrates an example Table/BS format 500 for reporting time-related information when only LCG has a data but three delay buckets are present, according to certain embodiments. For example, as depicted, one byte “P” field is associated to each LCG configured which report the delay buffer status information. Each P-field indicates whether a BS-field will be included and associated to the bucket represented by the P-field. Each P-field is associated to a range of time values, a bucket. For example, P1 could represent time between 0 and ≤5 ms, P2 time between 5 and ≤10 ms, P3 time between 10 and ≤15 ms, and so on. These buckets would have previously configured by the network.

Thus, for each LCG which was configured to report the delay buffer status, there will be a 1 “P” field byte, the L/N field or T field (as explained above in the different examples), and then followed the BS fields. There will be as many BS fields a P-fields set to 1 for the given LCG.

Alternatively, it could be that the pairs of 1 byte P-field and 1-byte L/N field per each LCG are present and after them, the BS fields associated to each triplet LCG-P-field-L/N field.

Alternatively to having explicit P fields in the delay format, the information could instead be implicitly provided by always reporting the BS size for the delay buckets configured for the specific LCG. This could still include the L/N bits in the same was as explained before (e.g. starting with one or multiple bytes indication L/N in one or multiple bits). Another option is to configure the delay buckets with a certain table, i.e. delay bucket 1 always use new table X and delay bucket 2 use legacy table and so on. In this way, it is possible to configure any number of delay buckets for each LCG (from one to infinity) as it would only change the number of rows reported for the BS sizes.

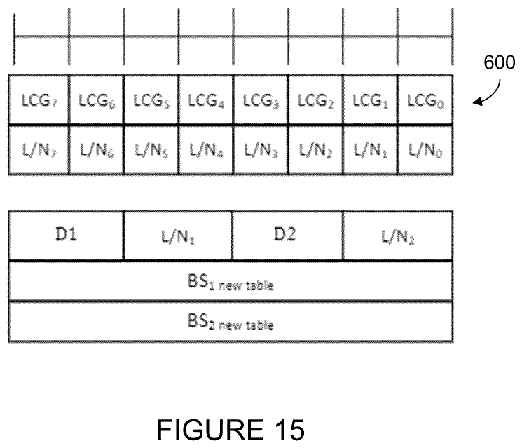

In yet another option, the delay format could include specific delay indexes (D) instead of the P fields. The delay index could consist of multiple bits, and indicate an index to a delay bucket in a pre-configured delay table. Those delay buckets could in similar fashion as for the P fields indicate a delay range. In this way the delay format would only indicate the delay buckets that contain data. The L/N bits are then reported only for the delay buckets that are included in the report. Depending on the number of delay buckets the number of bits needed to indicate the delay index would vary and also the number of rows needed would depend on how many delay buckets that have data. FIG. 15 illustrates an example Table/BS format 600, according to certain embodiments. Specifically, FIG. 15 illustrates an example of a delay reporting format when two delay buckets contain data. For example, in the illustrated embodiment, the report includes two delay indexes (D1 and D2) with associated L/N bits and BS tables. In this case, there are four delay buckets and, thus, two bits are needed for each delay index. With L/N bits in this example also being two bits, the delay index and L/N bits are fit into one octet.

In another embodiment, the L/N field and P field can be flexibly added depending on the number of LCG with “1”. If LCG field is set 0, there is no L/N field to correspond LCG and it can reduce overhead. The location of L/N field can be after LCG field or it can be added the beginning of each BS index byte. This method can be applied for all above methods.

In another embodiment, the number of LCG field can be also varying depending on how many LCGs are configured. If only 2 LCGs are configured by a network, the first byte for LCG will shrink to two bits.

If L/N field, P field, or LCG field are varying but BSR format should be byte dividable, a reserved bits can be added to make the size of BSR is divided by a byte.

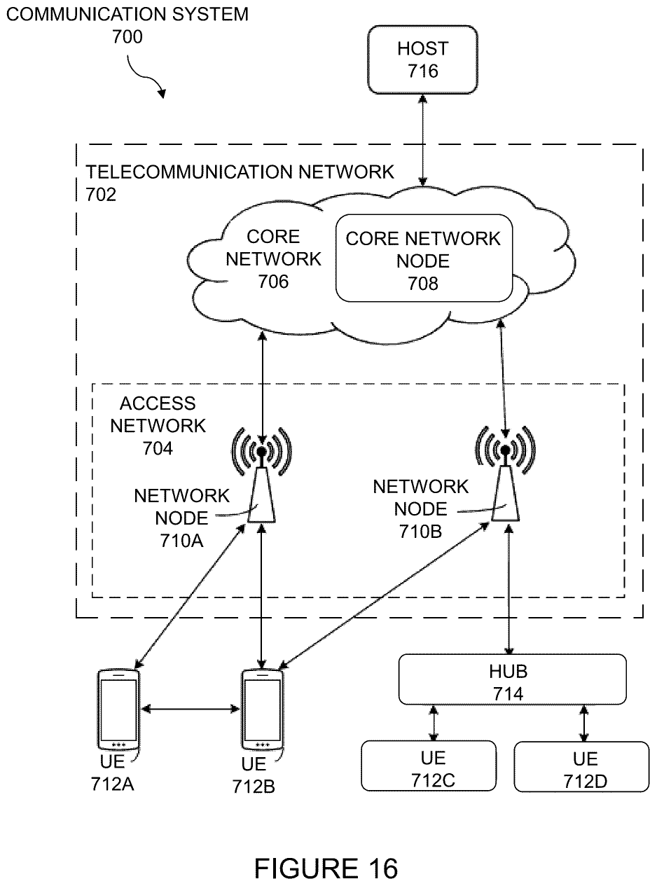

FIG. 16 shows an example of a communication system 700 in accordance with some embodiments. In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3rd Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 16 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

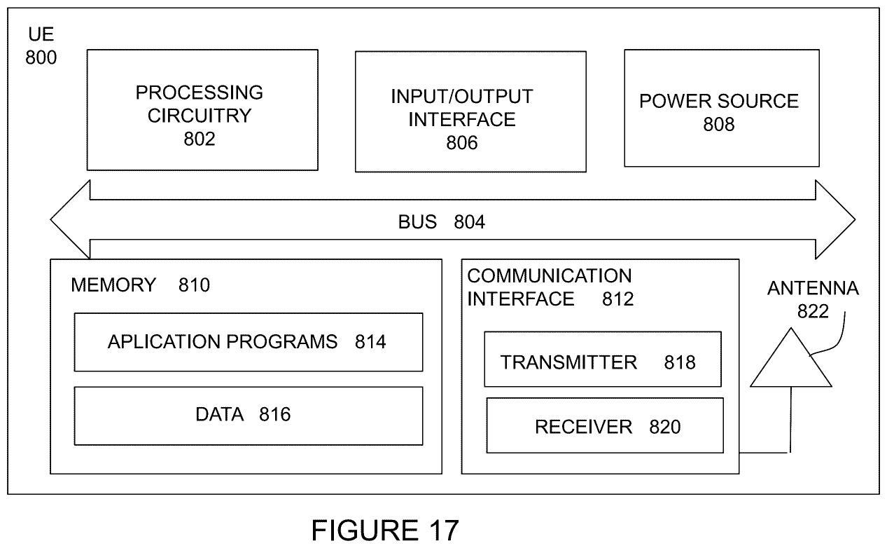

FIG. 17 shows a UE 800, which may be an embodiment of the UE 112 of FIG. 16, in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 17.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

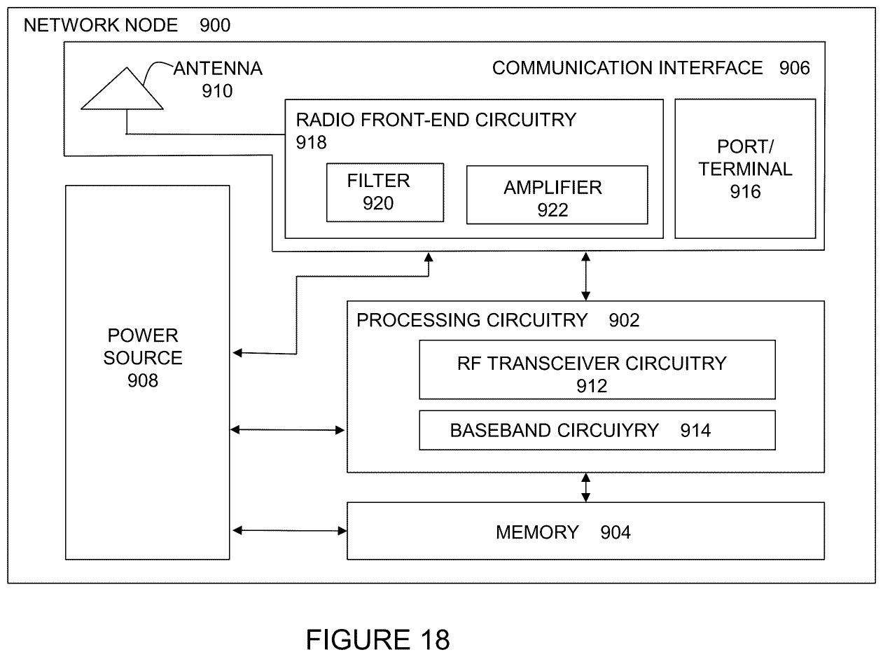

FIG. 18 shows a network node 900, which may be an embodiment of the network node 110 of FIG. 16, in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 18 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

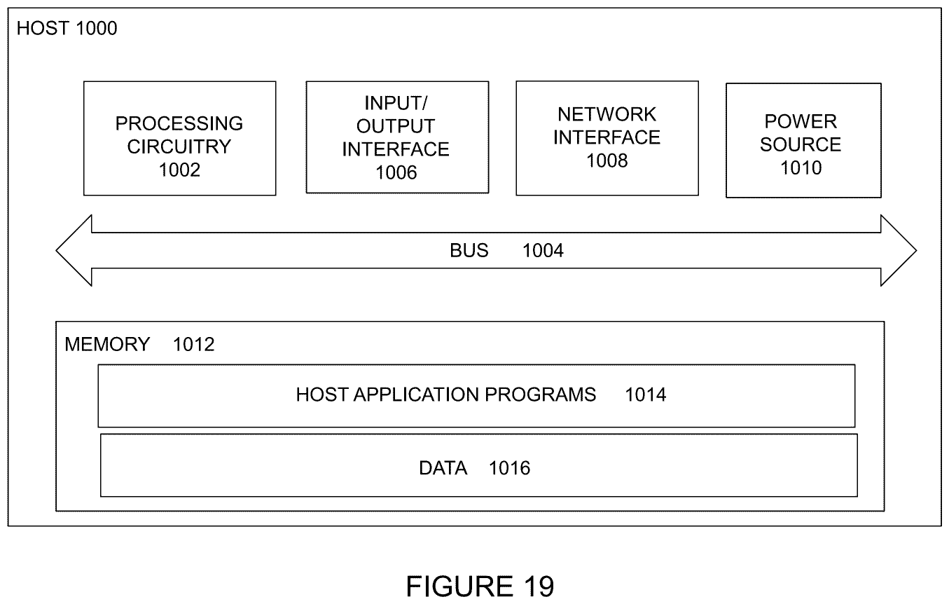

FIG. 19 is a block diagram of a host 1000, which may be an embodiment of the host 716 of FIG. 16, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

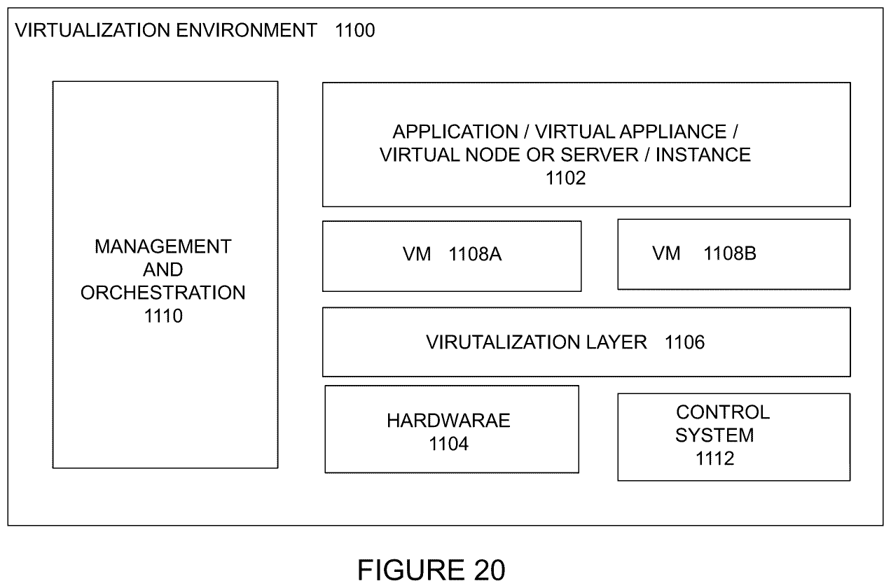

FIG. 20 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

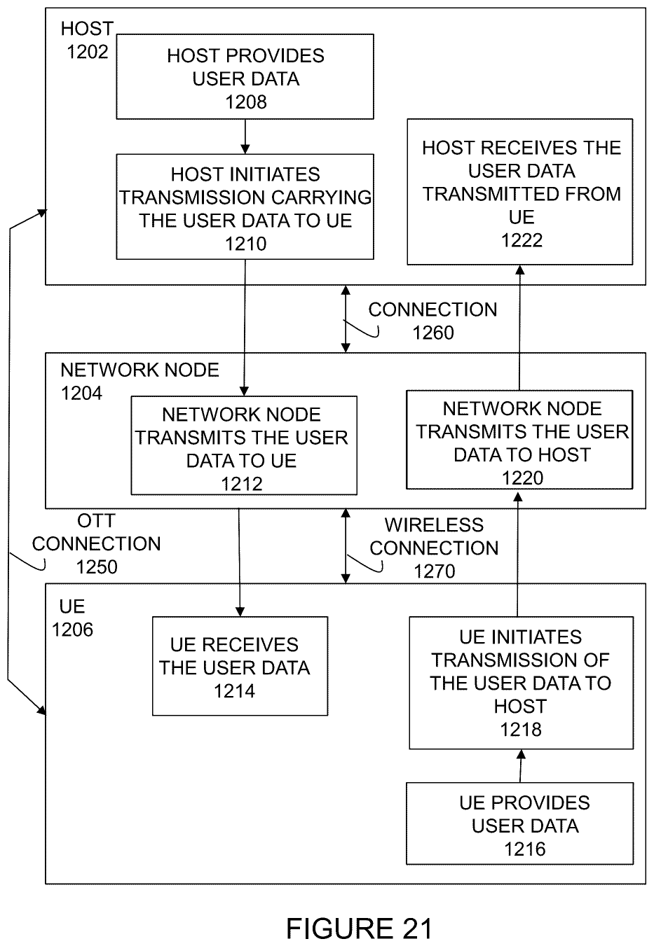

FIG. 21 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 16 and/or UE 800 of FIG. 17), network node (such as network node 710a of FIG. 16 and/or network node 900 of FIG. 18), and host (such as host 716 of FIG. 16 and/or host 1000 of FIG. 19) discussed in the preceding paragraphs will now be described with reference to FIG. 21.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 16) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

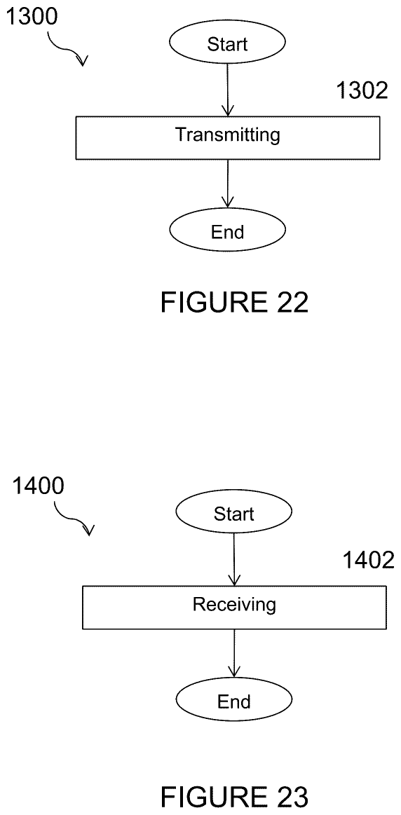

FIG. 22 illustrates an example method by a UE configured with a plurality of BS tables for use in preparing and/or transmitting a BSR, according to certain embodiments. In the illustrated embodiment, the method includes a transmitting step at QQ702. For example, at step QQ702, the UE may transmit, to a network node, information indicating at least one BS table and/or BS table index used for the BSR.

FIG. 23 illustrates an example method by a network node, according to certain embodiments. In the illustrated embodiment, the method includes a receiving step at 1402. For example, at step 1402, the network node may receive, from a UE configured with a plurality of BS tables for use in preparing and/or transmitting a BSR, information indicating at least one BS table and/or BS table index used for the BSR.

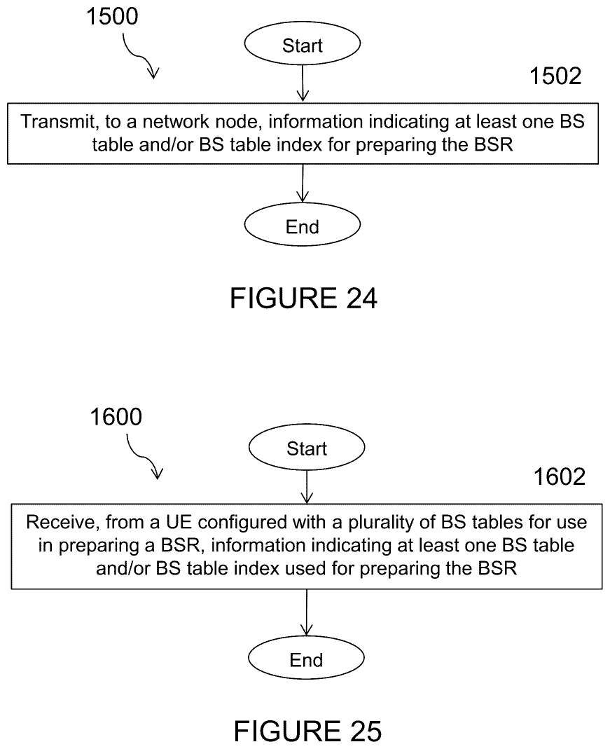

FIG. 24 illustrates a method 1500 performed by a UE 712 configured with a plurality of BS tables for use in preparing a BSR, according to certain amendments. As illustrated, the method includes, at step 1502, transmitting to a network node 710, information indicating at least one BS table and/or BS table index used for preparing the BSR.

In a particular embodiment, the UE is configured with a plurality of long BS tables and the information indicates one of the plurality of long BS tables used for preparing the BSR.

In a particular embodiment, the information indicates a particular long BSR table and/or long BS table index per logical channel group.

In a particular embodiment, the information is transmitted in a plurality of bit fields, and each bit field stores a bit, flag, and/or value indicating, for a respective one of a plurality of logical channel groups, a particular BSR table and/or BS table index used for the BSR for the respective logical channel group.

In a particular embodiment, each bit, flag, and/or value indicates whether the BS table used for preparing the BSR is from Release 17 or earlier or whether the BS table used for preparing the BSR is from Release 18 and later. Additionally or alternatively, each bit, flag, and/or value indicates whether the BS table index used for preparing the BSR is from Release 17 or earlier or whether the BS table index used for preparing the BSR is from Release 18 and later.

In a particular embodiment, the UE is configured with a plurality of BS tables and the information indicates one of the plurality of BS tables used to prepare a short BSR.

In a particular embodiment, the information is transmitted in a bit field, and the bit field stores a bit, flag, and/or value indicating a particular short BSR table and/or short BS table index used for the BSR.

In a particular embodiment, the information is transmitted with the BSR.

FIG. 25 illustrates a method 1600 performed by a network node 710, according to certain embodiments. As illustrated, the method includes, at step 1602, receiving 1602, from a UE 712, configured with a plurality of BS tables for use in preparing a BSR information indicating at least one BS table and/or BS table index used for preparing the BSR.

In a particular embodiment, the UE is configured to use a plurality of long BS tables when preparing the BSR and the information indicates one of the plurality of long BS tables used for preparing the BSR.

In a particular embodiment, the information indicates a particular long BSR table and/or long BS table index per logical channel group.

In a particular embodiment, the information is received in a plurality of bit fields, and each bit field stores a bit, flag, and/or value indicating, for a respective one of a plurality of logical channel groups, a particular BSR table and/or BS table index used for the BSR for the respective logical channel group.

In a particular embodiment, each bit, flag, and/or value indicates whether the BS table used for preparing the BSR is from Release 17 or earlier or whether the BS table used for preparing the BSR is from Release 18 and later. Additionally or alternatively, each bit, flag, and/or value indicates whether the BS table index used for preparing the BSR is from Release 17 or earlier or whether the BS table used for preparing the BSR is from Release 18 and later.

In a particular embodiment, the UE is configured with a plurality of BS tables and the information indicates one of the plurality of BS tables used for preparing a short BSR.

In a particular embodiment, the information is received in a bit field, and the bit field stores a bit, flag, and/or value indicating a particular short BSR table and/or short BS table index used for the BSR.

In a particular embodiment, the information is used for determining a size of an uplink grant.

In a particular embodiment, the information is transmitted with the BSR.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### Example Embodiments

### Group A Example Embodiments

Example Embodiment A1. A method performed by a user equipment (UE) configured with a plurality of Buffer Status (BS) tables for use in preparing and/or transmitting a Buffer Status Report (BSR), the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node, the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method performed by a user equipment (UE) configured with a plurality of Buffer Status (BS) tables for use in preparing and/or transmitting a Buffer Status Report (BSR), the method comprising: transmitting, to a network node, information indicating at least one BS table and/or BS table index used for the BSR.

Example Embodiment C2. The method of Example Embodiment C1, wherein at least one of: the UE is configured with a plurality of short BS tables and the information indicates one of the plurality of short BS tables used for the BSR, and/or the UE is configured with a plurality of long BS tables and the information indicates one of the plurality of long BS tables used for the BSR.

Example Embodiment C3. The method of any one of Example Embodiments C1 to C2, wherein the information indicates a particular BSR table and/or BS table index per logical channel group.

Example Embodiment C4. The method of any one of Example Embodiments C1 to C3, wherein: the information is transmitted in a plurality of bit fields, and each bit field stores a bit, flag, and/or value indicating, for a respective one of a plurality of logical channel groups, a particular BSR table and/or BS table index used for the BSR for the respective logical channel group.

Example Embodiment C5. The method of any one of Example Embodiments C3 to C4, wherein at least one of: each bit, flag, and/or value indicates whether a legacy BS table and/or new BS table is used, and/or each bit, flag, and/or value indicates whether a legacy BS table index and/or a new BS table index is used.

Example Embodiment C6. The method of Example Embodiments C1 to C5, further comprising: providing user data; and forwarding the user data to a host via the transmission to the network node.

Example Embodiment C7. A user equipment comprising processing circuitry configured to perform any of the methods of Example Embodiments C1 to C6.

Example Embodiment C8. A user equipment configured to perform any of the methods of Example Embodiments C1 to C6.

Example Embodiment C9. A wireless device comprising processing circuitry configured to perform any of the methods of Example Embodiments C1 to C6.

Example Embodiment C10. A computer program comprising instructions which when executed on a computer perform any of the methods of Example Embodiments C1 to C6.

Example Embodiment C11. A computer program product comprising computer program, the computer program comprising instructions which when executed on a computer perform any of the methods of Example Embodiments C1 to C6.

Example Embodiment C12. A non-transitory computer readable medium storing instructions which when executed by a computer perform any of the methods of Example Embodiments C1 to C6.

### Group D Example Embodiments

Example Embodiment D1. A method performed by a network node, the method comprising: receiving, from a User Equipment (UE) configured with a plurality of Buffer Status (BS) tables for use in preparing and/or transmitting a Buffer Status Report (BSR), information indicating at least one BS table and/or BS table index used for the BSR.

Example Embodiment D2. The method of Example Embodiment D1, comprising at least one of: configuring the UE with a plurality of short BS tables and the information indicates one of the plurality of short BS tables used for the BSR, and/or configuring the UE with a plurality of long BS tables and the information indicates one of the plurality of long BS tables used for the BSR.

Example Embodiment D3. The method of any one of Example Embodiments D1 to D2, wherein the information indicates a particular BSR table and/or BS table index per logical channel group.

Example Embodiment D4. The method of any one of Example Embodiments D1 to D3, wherein: the information is received in a plurality of bit fields, and each bit field stores a bit, flag, and/or value indicating, for a respective one of a plurality of logical channel groups, a particular BSR table and/or BS table index used for the BSR for the respective logical channel group.

Example Embodiment D5. The method of any one of Example Embodiments C3 to C4, wherein at least one of: each bit, flag, and/or value indicates whether a legacy BS table and/or new BS table is used, and/or each bit, flag, and/or value indicates whether a legacy BS table index and/or a new BS table index is used.

Example Embodiment D6. The method of any of the previous Example Embodiments, further comprising: obtaining user data; and forwarding the user data to a host or a user equipment.

Example Embodiment D7. A network node comprising processing circuitry configured to perform any of the methods of Example Embodiments D1 to D6.

Example Embodiment D8. A network node configured to perform any of the methods of Example Embodiments D1 to D6.

Example Embodiment D9. A computer program comprising instructions which when executed on a computer perform any of the methods of Example Embodiments D1 to D6.

Example Embodiment D10. A computer program product comprising computer program, the computer program comprising instructions which when executed on a computer perform any of the methods of Example Embodiments D1 to D6.

Example Embodiment D29. A non-transitory computer readable medium storing instructions which when executed by a computer perform any of the methods of Example Embodiments D1 to D24.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13. A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16. A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18. A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21. A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23. A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26. A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1. A method performed by a user equipment, UE, configured with a plurality of Buffer Status, BS, tables for use in preparing a Buffer Status Report, BSR, the method comprising:
transmitting, to a network node, information indicating at least one BS table and/or BS table index used for preparing the BSR.

2. The method of claim 1, wherein the UE is configured with a plurality of long BS tables and the information indicates one of the plurality of long BS tables used for preparing the BSR.

3. The method of claim 2, wherein the information indicates a particular long BSR table and/or long BS table index per logical channel group.

4. The method of claim 2, wherein:
the information is transmitted in at least one bit field, and
each bit field stores a bit, flag, and/or value indicating, for a respective one of a plurality of logical channel groups, a particular BSR table and/or BS table index used for the BSR for the respective logical channel group.

5. The method of claim 4, wherein at least one of:
each bit, flag, and/or value indicates whether the BS table used for preparing the BSR is from Release 17 or earlier or whether the BS table used for preparing the BSR is from Release 18 and later, and/or
each bit, flag, and/or value indicates whether the BS table index used for preparing the BSR is from Release 17 or earlier or whether the BS table index used for preparing the BSR is from Release 18 and later.

6. The method of claim 1, wherein the UE is configured with a plurality of BS tables and the information indicates one of the plurality of BS tables used to prepare a short BSR.

7. The method of claim 6, wherein:
the information is transmitted in a bit field, and
the bit field stores a bit, flag, and/or value indicating a particular short BSR table and/or short BS table index used for the BSR.

8. The method of claim 1, wherein the information is transmitted with the BSR.

9. A method performed by a network node, the method comprising:
receiving, from a User Equipment, UE, configured with a plurality of Buffer Status, BS, tables for use in preparing a Buffer Status Report, BSR, information indicating at least one BS table and/or BS table index used for preparing the BSR.

10. The method of claim 9, wherein the UE is configured to use a plurality of long BS tables when preparing the BSR and the information indicates one of the plurality of long BS tables used for preparing the BSR.

11. The method of claim 10, wherein the information indicates a particular long BSR table and/or long BS table index per logical channel group.

12. The method of claim 10, wherein:
the information is received in at least one bit field, and
each bit field stores a bit, flag, and/or value indicating, for a respective one of a plurality of logical channel groups, a particular BSR table and/or BS table index used for the BSR for the respective logical channel group.

13. The method of claim 12, wherein at least one of:
each bit, flag, and/or value indicates whether the BS table used for preparing the BSR is from Release 17 or earlier or whether the BS table used for preparing the BSR is from Release 18 and later, and/or
each bit, flag, and/or value indicates whether the BS table index used for preparing the BSR is from Release 17 or earlier or whether the BS table used for preparing the BSR is from Release 18 and later.

14. The method of claim 9, wherein the UE is configured with a plurality of BS tables and the information indicates one of the plurality of BS tables used for preparing a short BSR.

15. The method of claim 14, wherein:
the information is received in a bit field, and
the bit field stores a bit, flag, and/or value indicating a particular short BSR table and/or short BS table index used for the BSR.

16. The method of claim 9, comprising use the information for determining a size of an uplink grant.

17. The method of claim 9, wherein the information is transmitted with the BSR.

18. A user equipment, UE, configured with a plurality of Buffer Status, BS, tables for use in preparing a Buffer Status Report, BSR, the UE configured to:
transmit, to a network node, information indicating at least one BS table and/or BS table index used for preparing the BSR.

19. The UE of claim 18, wherein the UE is configured with a plurality of long BS tables and the information indicates one of the plurality of long BS tables used for preparing the BSR.

20. The UE of claim 19, wherein the information indicates a particular long BSR table and/or long BS table index per logical channel group.

21. The UE of claim 19, wherein:
the information is transmitted in at least one bit field, and
each bit field stores a bit, flag, and/or value indicating, for a respective one of a plurality of logical channel groups, a particular BSR table and/or BS table index used for the BSR for the respective logical channel group.

22. The UE of claim 21, wherein at least one of:
each bit, flag, and/or value indicates whether the BS table used for preparing the BSR is from Release 17 or earlier or whether the BS table used for preparing the BSR is from Release 18 and later, and/or
each bit, flag, and/or value indicates whether the BS table index used for preparing the BSR is from Release 17 or earlier or whether the BS table index used for preparing the BSR is from Release 18 and later.

23. The UE of claim 18, wherein the UE is configured with a plurality of BS tables and the information indicates one of the plurality of BS tables used to prepare a short BSR.

24. (canceled)

25. (canceled)

26. A network node configured to:
receive, from a User Equipment, UE, configured with a plurality of Buffer Status, BS, tables for use in preparing a Buffer Status Report, BSR, information indicating at least one BS table and/or BS table index used for preparing the BSR.

27.-34. (canceled)
